(19) United States
(12) Patent Application Publication
(10) Pub. No.: US 2017/0078200 A1
(43) Pub. Date: Mar. 16, 2017

(54) MULTI-TABLE HASH-BASED LOOKUPS FOR PACKET PROCESSING

(71) Applicants: Lizhong JIN, San Diego, CA (US); Xuyang ZHOU, San Diego, CA (US); Bibo MA, San Diego, CA (US); QUALCOMM INCORPORATED, San Diego, CA (US)

(72) Inventors: Lizhong Jin, Shanghai (CN); Xuyang Zhou, Shanghai (CN); Bibo Ma, Shanghai (CN)

(73) Assignee: QUALCOMM INCORPORATED, San Diego, CA (US)

(21) Appl. No.: 15/308,036

(22) PCT Filed: May 30, 2014
(86) PCT No.: PCT/CN2014/078907

§ 371 Date: Oct. 31, 2016

(51) Int. Cl. H04L 12/743

(52) U.S. Cl. CPC H04L 45/7453; H04L 45/742

(57) ABSTRACT

First and second hash values are generated using a key constructed from information associated with a packet. A block number is read from a cell in a slot in a first table, with the slot in the first table being indexed by the first hash value and the cell being indexed by the second hash value. A memory access operation directed to a block in a slot in a second table is performed to read data including packet-processing information for the packet from the block. The slot in the second table is indexed by the first hash value and the block is indexed by the block number. The packet is processed in accordance with the packet-processing information.

### TECHNICAL FIELD

The present embodiments relate generally to packet processing, and specifically to hash tables used for lookups in packet processing.

### BACKGROUND OF RELATED ART

In a packet-processing chip, packet information (e.g., metadata from the packet header) may be used as a key to look up packet-processing information in a lookup table. The packet-processing information is used for packet forwarding and/or classification. For example, the key is used to look up forwarding information in a forwarding table. The lookup table (e.g., the forwarding table) is divided into multiple slots. Each slot may have multiple cells to store respective collision elements. Each collision element stores packet-processing information for a respective key as well as the key itself. The slots are indexed using a hash function h(k), where k is the key. Multiple collision elements are included in each slot because the hash function maps multiple keys to the same slot. To search for packet-processing information for a specific key k, the collision elements in a slot with index h(k) may be read and the key values stored in the collision elements compared to k. A match indicates that the matching collision element stores the packet-processing information for k.

The usage rate for the lookup table (e.g., the forwarding table) may be increased by increasing the number of cells, and thus collision elements, per slot: the likelihood of a successful lookup increases as the number of collision elements per slot increases. However, increasing the number of cells per slot increases the amount of data to be read from a slot when performing a lookup, which increases the latency for processing a packet. Increased latency results in decreased performance.

Accordingly, there is a need for packet-processing lookup techniques that limit memory access but provide a high usage rate.

### SUMMARY

In some embodiments, a packet-processing method includes generating first and second hash values using a key that was constructed from information associated with a packet. A block number is read from a cell in a slot in a first table, with the slot in the first table being indexed by the first hash value and the cell being indexed by the second hash value. A memory access operation directed to a block in a slot in a second table is performed to read data including packet-processing information for the packet from the block. The slot in the second table is indexed by the first hash value and the block is indexed by the block number. The packet is processed in accordance with the packet-processing information.

In some embodiments, a method of maintaining a lookup table used for packet processing includes creating a first table divided into a first plurality of slots and creating a second table divided into a second plurality of slots. Each slot of the first plurality of slots is divided into a plurality of cells. Each slot of the second plurality of slots is divided into a plurality of blocks. First and second hash values are generated using a key. The key and packet-processing information associated with the key are stored in a respective block in a respective slot in the second table, with the respective slot in the second table being indexed by the first hash value and the respective block being indexed by a block number. The block number is stored in a respective cell in a respective slot in the first table, with the respective slot in the first table being indexed by the first hash value and the respective cell in the respective slot in the first table being indexed by the second hash value.

In some embodiments, a packet-processing system includes a hashing module to generate first and second hash values using a key constructed from information associated with a packet. The packet-processing system also includes a table-access module to read a block number from a cell in a slot in a first table and to perform a memory access directed to a block in a slot in a second table, to read data including packet-processing information from the block. The slot in the first table is indexed by the first hash value and the cell is indexed by the second hash value. The slot in the second table is indexed by the first hash value and the block is indexed by the block number. The packet-processing system further includes a packet-processing module to process the packet in accordance with packet-processing information read from the block.

### BRIEF DESCRIPTION OF THE DRAWINGS

The present embodiments are illustrated by way of example and are not intended to be limited by the figures of the accompanying drawings.

FIG. 1 is a block diagram of a system for processing packets in accordance with some embodiments.

FIG. 2A is a block diagram of a hash table and corresponding stub table in accordance with some embodiments.

FIG. 2B shows a block in the hash table of FIG. 2A in accordance with some embodiments.

FIG. 3 is a block diagram showing two hash tables with two corresponding stub tables in accordance with some embodiments.

FIGS. 4A and 4B show a flowchart of a method of processing packets in accordance with some embodiments.

FIGS. 5A and 5B show a flowchart of a method of maintaining a lookup table in accordance with some embodiments.

Like reference numerals refer to corresponding parts throughout the drawings and specification.

### DETAILED DESCRIPTION

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

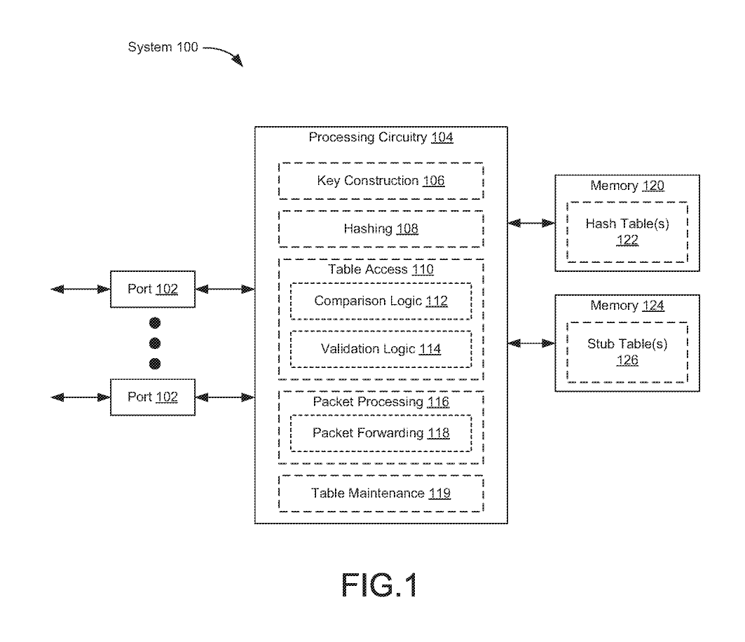

FIG. 1 is a block diagram of a system 100 for processing packets in accordance with some embodiments. In some embodiments, the system 100 is part of a network switch or router. The system 100 includes a plurality of ports 102 that receive and transmit packets. The ports 102 are coupled to processing circuitry 104, which is coupled to memory 120 and memory 124. The processing circuitry 104 may be coupled to the memory 120 and/or the memory 124 through a memory controller (not shown for simplicity).

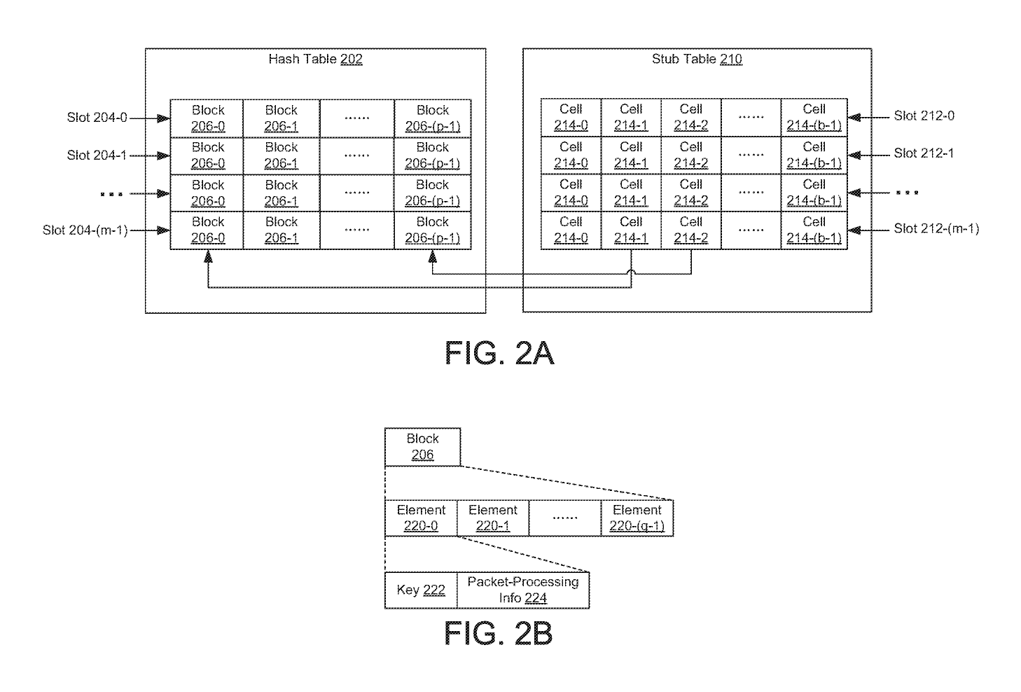

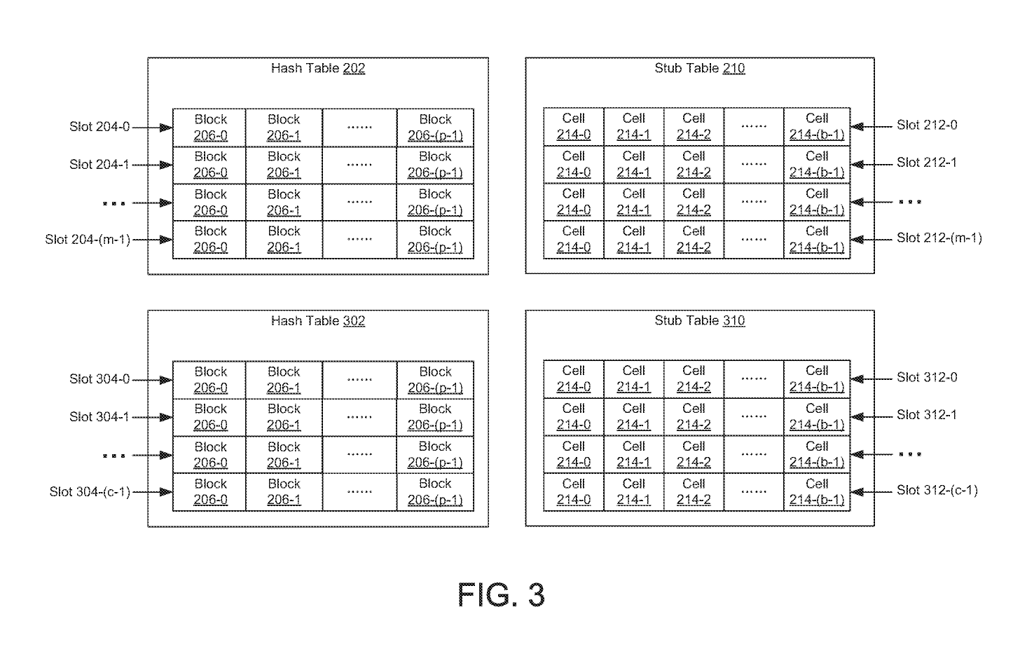

The memory 120 stores one or more hash tables 122, which store packet-processing information that specifies how to process respective packets. The one or more hash tables 122 are each divided into slots, which may also be referred to as buckets. The slots are divided into blocks, which are divided into cells. The cells may also be referred to as bins. Each cell stores a collision element; each collision element stores packet-processing information for a respective key as well as the key itself. The memory 124 stores one or more stub tables 126. The one or more stub tables 126 are each divided into slots, which are each divided into cells. The cells in the one or more stub tables 126 store pointers to blocks in the one or more hash tables 122 in accordance with some embodiments. (The term “cell” as used herein refers to a portion of a slot. In a hash table 122, a cell stores a collision element. In a stub table 126, a cell stores a block number that points to block in a corresponding hash table 122. A “cell” as the term is used herein therefore is not the same thing as a “memory cell.” To the contrary, each cell in a slot will include multiple memory cells.) Examples of the one or more hash tables 122 and the one or more stub tables 126 are described below with respect to FIGS. 2A, 2B, and 3.

The processing circuitry 104 includes a key-construction module 106, a hashing module 108, a table-access module 110, a packet-processing module 116, and a table-maintenance module 119. The key-construction module 106 constructs keys used in looking up the packet-processing information stored in the one or more hash tables 122. The keys are constructed using information associated with (e.g., extracted from) packets, in accordance with a key-construction rule. For example, the keys may be constructed using metadata extracted from packet headers. In one example, the destination addresses of packet headers are extracted and used as keys. In another example, the entire packet headers (e.g., the Internet Protocol (IP) headers) of packets are extracted and used as keys.

The keys constructed by the key-construction module 106 are provided to the hashing module 108, which hashes the keys to generate hash values. The hashing module 108 may generate multiple hash values for a respective key. In some embodiments, the hashing module 108 implements multiple hash functions. For example, the hashing module 108 may apply a first hash function h1 to a key k to generate a first hash value h1(k) and apply a second hash function h2 to the key k to generate a second hash value h2(k). The hashing module 108 may further apply a third hash function h3 to the key k to generate a third hash value h3(k) and apply a fourth hash function h4 to the key k to generate a fourth hash value h4(k). The use of distinct hashing functions is merely one example of generating the hash values h1(k), h2(k), h3(k), and/or h4(k); other examples are possible.

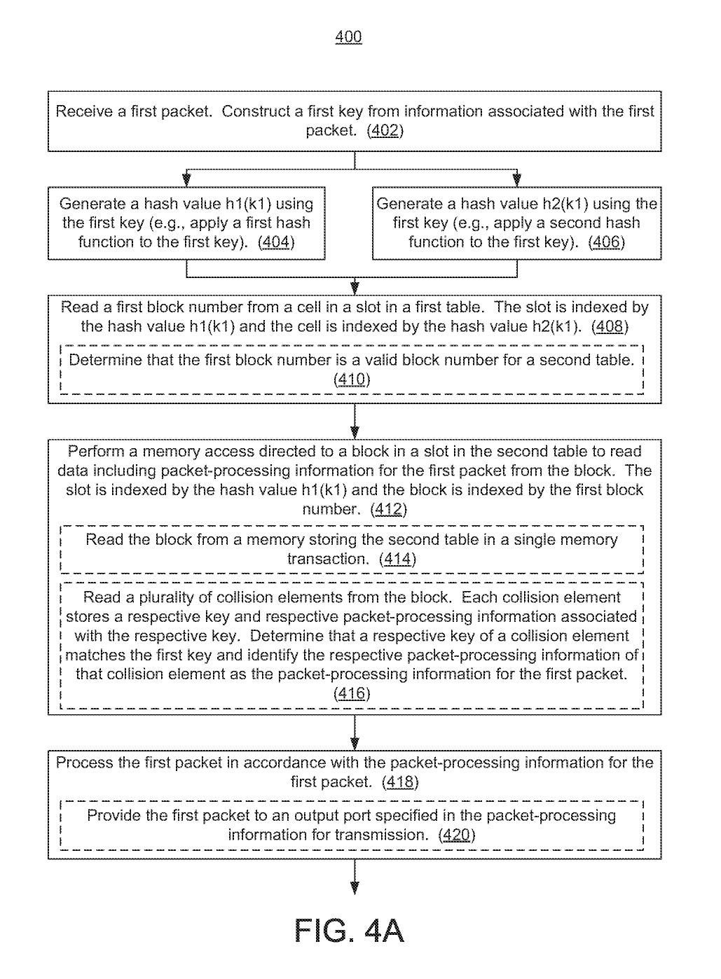

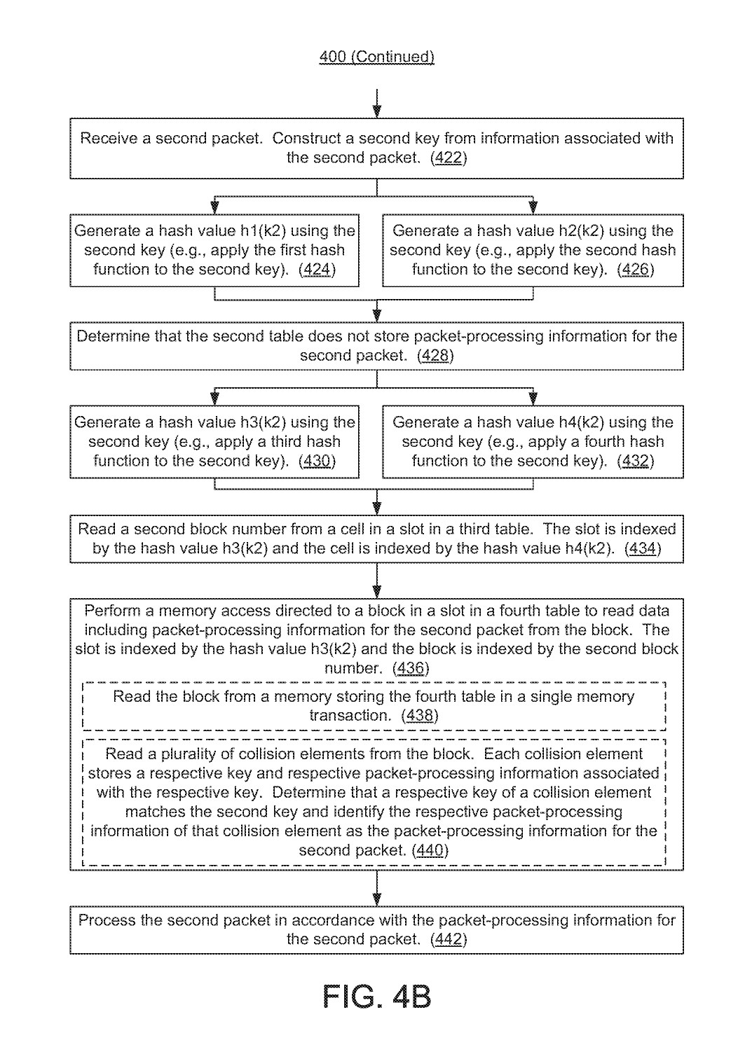

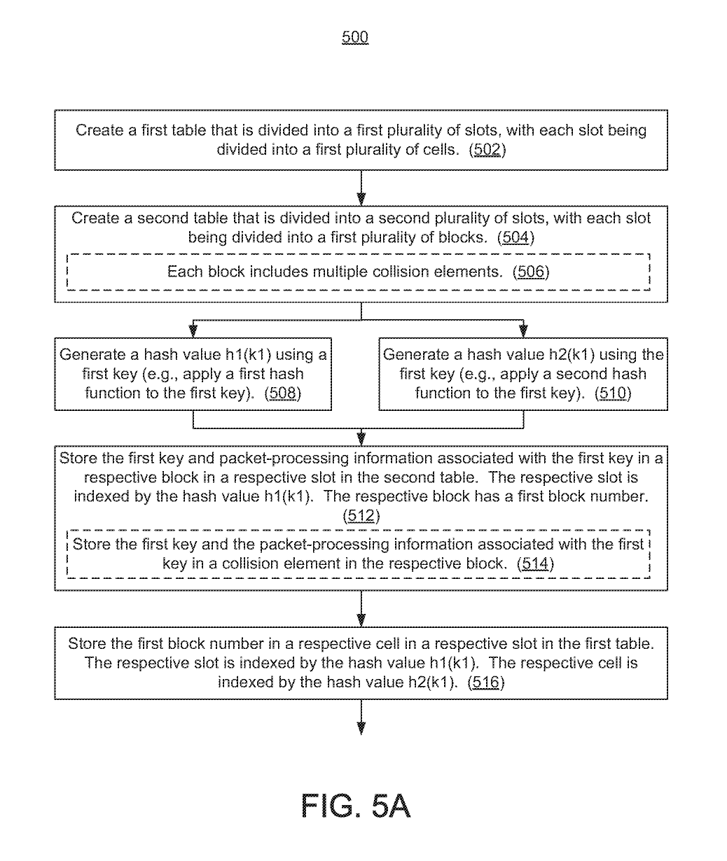

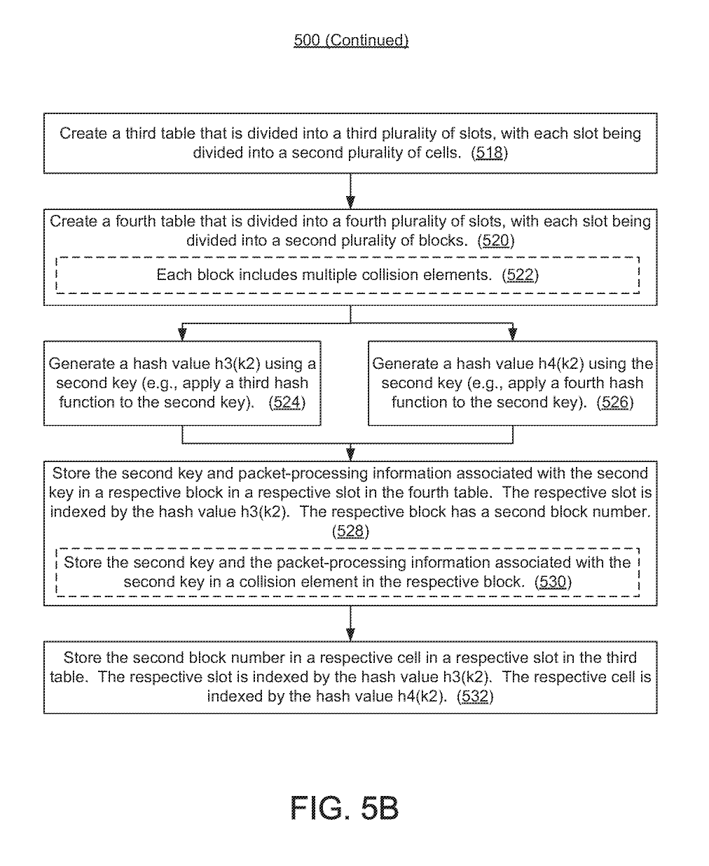

The hash values generated by the hashing module 108 are provided to the table-access module 110 along with the key constructed by the key-construction module 106. The table-access module 110 uses the hash values to access the one or more stub tables 126 and the one or more hash tables 122. Examples of using hash values to access these tables are provided below with respect to FIGS. 2A and 3, and also in the method 400 of FIGS. 4A-4B and the method 500 of FIGS. 5A-5B. In some embodiments, the table-access module 110 includes comparison logic 112 to compare keys read from collision elements in a hash table 122 to keys provided by the key-construction module 106. In some embodiments, the table-access module 110 includes validation logic 114 to determine whether a block number read from a cell in a stub table 126 is a valid block pointer.

Packet-processing information retrieved from a hash table 122 by the table-access module 110 is provided to the packet-processing module 116, which processes packets in accordance with the packet-processing information. In some embodiments, the packet-processing module 116 includes a packet-forwarding engine 118 that routes packets to output ports 102 specified by the packet-processing information for transmission.

The table-maintenance module 119 builds and updates the one or more hash tables 122 and the one or more stub tables 126. For example, the table-maintenance module 119 stores keys and corresponding packet-processing information in the one or more hash tables 122 and stores corresponding block numbers in the one or more stub tables 126.

In some embodiments, the memory 120 is external to the processing circuitry 104. For example, the processing circuitry 104 is implemented in a packet-processing chip, while the memory 120 is implemented in one or more external memory chips. The memory 124 may be embedded in the same integrated circuit (i.e., the same chip) as the processing circuitry 104 (e.g., as cache memory). Alternatively, the memory 124 may be implemented in one or more memory chips that are external to the integrated circuit (e.g., the packet-processing chip) that includes the processing circuitry 104. In some embodiments, the memory 120 is dynamic random-access memory (DRAM) and the memory 124 is static random-access memory (SRAM). In some embodiments, the memory 120 is double-data-rate (DDR) memory (e.g., DDR DRAM).

FIG. 2A is a block diagram of a hash table 202 and corresponding stub table 210 in accordance with some embodiments. The hash table 202 is an example of a hash table 122 in the memory 120 (FIG. 1) and the stub table 210 is an example of a stub table 126 in the memory 124 (FIG. 1). The hash table 202 is divided into m slots (i.e., buckets) 204, where m is an integer greater than one, such that the hash table 202 includes slots 204-0 through 204-(m-1). The slots 204-0 through 204-(m-1) are indexed using a first set of hash values h1(k) (e.g., using a first hash function h1(k)), where the values of h1(k) range between 0 and (m-1). The value of h1(k), as applied to a particular key k, thus gives the index of a slot 204 in the hash table 202.

Each slot 204 in the hash table 202 is divided into p blocks 206, where p is an integer greater than one, such that each slot 204 includes blocks 206-0 through 206-(p-1). FIG. 2B shows a block 206 in accordance with some embodiments. The block 206 is divided into q cells storing q respective collision elements 220, where q is an integer greater than one, such that the block includes collision elements 220-0 through 220-(q-1). Each collision element 220 includes a key 222 and packet-processing information 224. Each block 206 may be accessed independently of other blocks 206 in the same slot 204. In some embodiments, the block 206 has a size x (e.g., in bytes) that allows it to be read from the memory 120 in a single memory transaction (e.g., a single bus-request transaction for a data bus coupling the memory 120 to the processing circuitry 104). Many factors may influence the selection of the value of x to improve system efficiency (e.g., data-burst size, cache-line size). For example (e.g., when the memory 120 is DDR), a bus-request transaction may refer to a single burst of data read from the memory 120, such that the block 206 has a size x equal to the number of bytes per data burst for the memory 120. In one example, the memory 120 is DRAM with 128 bytes (i.e., 128B) per data burst and the block 206 is 128B (i.e., x=128B). Each collision element 220, and thus each cell, is y bytes, such that q=ceiling(x/y, 1) (i.e., x divided by y, rounded up to the nearest integer). Each slot 204 has n collision elements, and thus n cells. Each slot 204 thus is divided into p blocks 206, where p=ceiling(n/q, 1).

The stub table 210 is divided into m slots 212, such that the stub table includes slots 212-0 through 212-(m-1). The slots 212-0 through 212-(m-1), like the slots 204-0 through 204-(m-1) in the hash table 202, are indexed using the first set of hash values h1(k) (e.g., using the first hash function h1(k)). Each slot 212 is divided into b cells 214, where b is an integer greater than or equal to p, such that each slot includes cells 214-0 through 214-(b-1). In one example, b equals n. The size of each cell 214 is ceiling(log₂(p), 1) (i.e., the base-2 logarithm of the number of blocks 206 in each slot 204 of the hash table 202, rounded up to the nearest integer). The size of the stub table 210 in bits is ceiling(log₂(p), 1)*m*b.

The cells 214-0 through 214-(b-1) are indexed using a second set of hash values h2(k) (e.g., using a second hash function h2(k)), where the values of h2(k) range between 0 and b-1. The value of h2(k), as applied to a particular key k, thus gives the index of a cell 214 in the stub table 210. The cells 214-0 through 214-(b-1) in a slot 212 store block numbers of blocks 206 in a corresponding slot 204 in the hash table 202. In the example of FIG. 2A, cell 214-1 in slot 212-(m-1) stores a ‘0’, which is the block number of block 206-0 in slot 204-(m-1) of the hash table 202. Cell 214-2 in slot 212-(m-1) stores the value ‘p-1’, which is the block number of block 206-(p-1) in slot 204-(m-1) of the hash table 202. Cell 214-1 in slot 212-(m-1) thus stores a pointer to block 206-0 in slot 204-(m-1), and cell 214-2 in slot 212-(m-1) thus stores a pointer to block 206-(p-1) in slot 204-(m-1). In some embodiments, each cell 214 may be accessed independently of other cells 214 in the same slot 212.

Accordingly, the collision element 220 for a key k is stored in the hash table 202 in a block 206 specified by the block number stored in a corresponding cell 214 in the stub table 210. The corresponding cell 214 is indexed by h2(k) and is in a slot 212 indexed by h1(k), while the collision element 220 is in a slot 204 indexed by h1(k).

In one example, the hash table 202 is implemented in DRAM and the stub table 210 is implemented in SRAM, with m=8k, n=16, x=128B, y=32B, and b=16. Thus, p=4 and q=4. The size of the hash table 202 is therefore 8k*16*32B=4 megabytes (MB), and the size of the stub table 219 is therefore 2*8k*16 bits=256 kilobits=32 kilobytes (KB). The 4MB DRAM hash table 202 provides a high usage rate in accordance with some applications, while the addition of the 32KB SRAM stub table 210 storing block numbers limits the size of DRAM accesses, resulting in low latency.

If the hash table 202 does not include a collision element for a key used in a lookup, the lookup will fail. The likelihood of a lookup failing may be reduced by increasing the load factor of the system 100. Load factor is defined as the number of entries divided by the number of buckets (i.e., slots), where the number of entries refers to the number of entries successfully inserted into the table. It is desirable for the system 100 to have a high load factor combined with a low collision rate. To improve the load factor while achieving a low collision rate, a second hash table 122 and corresponding stub table 126 may be included in the system 100.

FIG. 3 is a block diagram showing a second hash table 302 and second stub table 310 that may be used in conjunction with the hash table 202 and stub table 210 (FIG. 2A) in accordance with some embodiments. The hash table 302 is an example of a hash table 122 in the memory 120 (FIG. 1) and the stub table 310 is an example of a stub table 126 in the memory 124 (FIG. 1). The hash table 302 and stub table 310 may be accessed in response to a determination that the hash table 202 does not store a collision element for a particular key.

The hash table 302 is divided into c slots (i.e., buckets) 304, where c is an integer greater than one, such that the hash table 302 includes slots 304-0 through 304-(c-1). The slots 304-0 through 304-(c-1) are indexed using a third set of hash values h3(k) (e.g., a third hash function h3(k)), where the values of h3(k) range between 0 and (c-1). Each slot 304 is divided into p blocks 206, such that each slot 304 includes blocks 206-0 through 206-(p-1). Each slot 206 may be accessed independently of other blocks 206 in the same slot 304, as described for blocks 206 in the hash table 202. The stub table 310 is divided into c slots 312, such that the stub table 310 includes slots 312-0 through 312-(c-1). The slots 312-0 through 312-(c-1), like the slots 304-0 through 304-(c-1), are indexed using the third set of hash values h3(k) (e.g., the third hash function h3(k)). Each slot 312 is divided into b cells 214, such that each slot 312 includes cells 214-0 through 214-(b-1). The cells 214-0 through 214-(b-1) are indexed using a fourth set of hash values h4(k) (e.g., a fourth hash function h4(k)), where the values of h4(k) range between 0 and (b-1). The cells 214-0 through 214-(b-1) in each slot 312 of the stub table 310 store block numbers that point to blocks 206 in a corresponding slot 304 in the hash table 302. In some embodiments, each cell 214 may be accessed independently of other cells 214 in the same slot 312.

Collision elements 220 for keys k thus are stored in the hash table 302 in blocks 206 specified by block numbers stored in corresponding cells 214 in the stub table 310. The corresponding cells 214 are indexed by h4(k) and are in slots 312 indexed by h3(k), while the collision elements 220 are in slots 304 indexed by h3(k).

In the example of FIG. 3, the number of blocks 206 in each slot 204 of the hash table 202 is shown as being equal to the number of blocks 206 in each slot 304 of the hash table 302. These numbers, however, may differ. Similarly, the number of cells 214 in each slot 212 of the stub table 210 is shown as being equal to the number of cells 214 in each slot 312 of the stub table 310. These numbers, however, may differ.

FIGS. 4A and 4B show a flowchart of a method 400 of processing packets in accordance with some embodiments. The method 400 is performed, for example, in the system 100 (FIG. 1).

In the method 400, a first packet is received. A first key k1 is constructed (402, FIG. 4A) from information associated with the first packet (e.g., from metadata in the packet header). The first key is constructed, for example, by the key-construction module 106 (FIG. 1).

Hash values h1(k1) and h2(k1) are generated (404, 406) using the first key. For example, a first hash function is applied to the first key to determine the hash value h1(k1) and a second hash function is applied to the first key to determine the hash value h2(k1). The hashing operations 404 and 406 are performed, for example, by the hashing module 108 (FIG. 1).

A first block number is read (408) (e.g., by the table access module 110, FIG. 1) from a cell in a slot in a first table (e.g., from a cell 214 in a slot 212 in the stub table 210, FIG. 2A). The slot is indexed by the hash value h1(k1) and the cell is indexed by the hash value h2(k1). In some embodiments, the cell is read without reading other cells in the slot. In some embodiments, the first block number is read from a memory storing the first table (e.g., in the memory 124, FIG. 1) in a single transaction (e.g., a single memory access). In some embodiments, the memory storing the first table is SRAM.

In some embodiments, it is determined (410) (e.g., by the validation logic 114, FIG. 1) that the first block number is a valid block number for a second table.

A memory access directed to a block (e.g., a block 206, FIG. 2B) in a slot in the second table (e.g., in a slot 204 in the hash table 202, FIG. 2A) is performed (412) to read data including packet-processing information (e.g., packet-processing information 224, FIG. 2B) for the first packet. The memory access is performed, for example, by the table access module 110, FIG. 1. The slot is indexed by the hash value h1(k1) and the block is indexed by the first block number. In the memory access, the block is read without reading other blocks in the slot. In some embodiments, the packet-processing information includes packet-forwarding information (e.g., specifying an output port 102, FIG. 1). In some embodiments, the block is read (414) from a memory storing the second table (e.g., in the memory 120, FIG. 1) in a single memory transaction (e.g., a single bus-request transaction, an example of which is a single burst). In some embodiments, the memory storing the second table is DRAM.

The block may be read in response to determining (410) that the first block number is a valid block number for the second table. Alternatively, the determination of operation 410 may be omitted.

In some embodiments, a plurality of collision elements 220-0 through 220-(q-1) (FIG. 2B) are read (416) from the block. Each collision element 220 stores a respective key 222 and respective packet-processing information 224 associated with the respective key 222. It is determined (e.g., using the comparison logic 112, FIG. 1) that a respective key 222 of one of the collision elements 220-0 through 220-(q-1) matches the first key. The respective packet-processing information 224 of that collision element 220 is identified as the packet-processing information for the first packet.

In some embodiments, to read the plurality of collision elements 220-0 through 220-(q-1), a memory offset in the memory storing the second table (e.g., in the memory 120) is determined using the expression:

(h1(k1*n+q*(first block number))*y (1)

where h1(k1) is the hash value generated in operation 404, n is a number of collision elements 220 in each slot of the second table (e.g., in each slot 204 of the hash table 202, FIG. 2A), q is a number of collision elements 220 in the plurality of collision elements 220-0 through 220-(q-1), and y is a size of each collision element 220. The plurality of collision elements 220-0 through 220-(q-1) are then read from a memory location having the memory offset (e.g., with respect to the starting location of the hash table 202 in the memory 120).

The first packet is processed (418) in accordance with the packet-processing information for the first packet. In some embodiments, the first packet is provided (420) to an output port specified by the packet-processing information for transmission. For example, the packet forwarding engine 118 routes the first packet to a specified port 102 (FIG. 1).

In some embodiments, a second packet is received (422, FIG. 4B). A second key k2 is constructed (422) from information associated with the second packet (e.g., from metadata in the packet header). The second key is constructed, for example, by the key-construction module 106 (FIG. 1).

Hash values h1(k2) and h2(k2) are generated (424, 426) using the second key. For example, the first hash function is applied to the second key to determine the hash value h1(k2) and the second hash function is applied to the second key to determine the hash value h2(k2). The hashing operations 424 and 426 are performed, for example, by the hashing module 108 (FIG. 1)

Using the hash values h1(k2) and h2(k2), it is determined (428) that the second table (e.g., the hash table 202, FIG. 2A) does not store packet-processing information for the second packet. For example, a cell indexed by h2(k2) in a slot indexed by h1(k2) in the first table (e.g., a cell 214 in a slot 212 in the stub table 210, FIG. 2A) is read, and a determination is made that a value read from the cell indicates that the second table does not store packet-processing information for the second packet. For example, the validation logic 114 (FIG. 1) determines that the value read from the cell is not a valid block number.

Hash values h3(k2) and h4(k2) are generated (430, 432) using the second key. For example, a third hash function is applied to the second key to determine the hash value h3(k2) and a fourth hash function is applied to the second key to determine the hash value h4(k2). The hashing operations 430 and 432 are performed, for example, by the hashing module 108 (FIG. 1).

A second block number is read (434) from a cell in a slot in a third table (e.g., a cell 214 in a slot 312 in the stub table 310, FIG. 3). The slot is indexed by the hash value h3(k2) and the cell is indexed by the hash value h4(k2). In some embodiments, the cell is read without reading other cells in the slot. In some embodiments, the second block number is read from a memory storing the third table (e.g., in the memory 124, FIG. 1) in a single transaction (e.g., a single memory access). In some embodiments, the memory storing the third table is SRAM.

A memory access directed to a block (e.g., a block 206, FIG. 2B) in a slot in a fourth table (e.g., in a slot 304 in the hash table 302, FIG. 3) is performed (436) to read data including packet-processing information (e.g., packet-processing information 224, FIG. 2B) for the second packet. The slot is indexed by the hash value h3(k2) and the block is indexed by the second block number. In the memory access, the block is read without reading other blocks in the slot. In some embodiments, the block is read (438) from a memory storing the fourth table (e.g., in the memory 120, FIG. 1) in a single memory transaction (e.g., a single bus-request transaction, an example of which is a single burst). In some embodiments, the memory storing the fourth table is DRAM.

In the operation 436, a plurality of collision elements 220-0 through 220-(q-1) (FIG. 2B) may be read (440) from the block. Each collision element 220 stores a respective key 222 and respective packet-processing information 224 associated with the respective key 222. It is determined (e.g., using the comparison logic 112, FIG. 1) that a respective key 222 of one of the collision elements 220-0 through 220-(q-1) matches the second key. The respective packet-processing information 224 in that collision element 220 is identified as the packet-processing information for the second packet.

In some embodiments, to read the plurality of collision elements 220-0 through 220-(q-1) in the operation 440, a memory offset in the memory storing the fourth table (e.g., in the memory 120) is determined using the expression:

(h3(k2)*n+q*(second block number))*y (2)

where h3(k2) is the hash value generated in operation 430, n is a number of collision elements 220 in each slot of the fourth table (e.g., in each slot 304 of the hash table 302, FIG. 3), q is a number of collision elements 220 in the plurality of collision elements 220-0 through 220-(q-1), and y is a size of each collision element 220. The plurality of collision elements 220-0 through 220-(q-1) are then read from a memory location having the memory offset (e.g., with respect to the start of the hash table 302 in the memory 120).

The read operations 434 and 436 are performed, for example, by the table access module 110 (FIG. 1).

The second packet is processed (442) in accordance with the packet-processing information for the second packet. In some embodiments, the second packet is provided to an output port specified by the packet-processing information for transmission. For example, the packet forwarding engine 118 routes the second packet to a specified port 102 (FIG. 1).

The method 400 provides low-latency table lookups by limiting the size of memory accesses for the second and/or fourth tables to a block within a slot, as opposed to the entire slot. The method 400 also may limit the size of memory accesses for the first and/or third tables to a cell within a slot, as opposed to the entire slot. Storing block numbers in the first and/or third tables allows the number of collision elements in each slot of the second and/or fourth tables to be increased without increasing latency. A large lookup table with a high usage rate and high load factor combined with a low collision rate and low latency can thereby be achieved.

While the method 400 includes a number of operations that appear to occur in a specific order, it should be apparent that the method 400 can include more or fewer operations and that some of the operations can be executed serially or in parallel. An order of two or more operations may be changed, performance of two or more operations may overlap, and two or more operations may be combined into a single operation.

FIGS. 5A and 5B show a flowchart of a method 500 of maintaining a lookup table in accordance with some embodiments. The method 500 is performed, for example, in the system 100 (FIG. 1) and may be performed in conjunction with the method 400 (FIGS. 4A-4B).

In the method 500, a first table (e.g., stub table 210, FIG. 2A) is created (502, FIG. 5A) that is divided into a first plurality of slots (e.g., slots 212-0 through 212-(m-1)), with each slot being divided into a first plurality of cells (e.g., cells 214-0 through 214-(b-1)). For example, the first table is stored in the memory 124 (FIG. 1), which in some embodiments is SRAM. In some embodiments, each cell is independently accessible in the memory 124 (e.g., in a single respective memory transaction).

A second table (e.g., hash table 202, FIG. 2A) is created (504) that is divided into a second plurality of slots (e.g., slots 204-0 through 204-(m-1)), with each slot being divided into a first plurality of blocks (e.g., blocks 206-0 through 206-(p-1)). For example, the second table is stored in the memory 120 (FIG. 1), which in some embodiments is DRAM. In some embodiments, each block includes (506) multiple collision elements (e.g., collision elements 220-0 through 220-(q-1), FIG. 2B). In some embodiments, each block is independently accessible in the memory 120 (e.g., in a single bus-request transaction, an example of which is a burst). For example, the size of each block may be equal to the number of bytes per data burst for the memory 120.

Hash values h1(k1) and h2(k1) are generated (508, 510) using a first key k1. For example, a first hash function is applied to the first key to determine the hash value h1(k1) and a second hash function is applied to the first key to determine the hash value h2(k1). The hashing operations 508 and 510 are performed, for example, by the hashing module 108 (FIG. 1).

The first key and packet-processing information associated with the first key are stored (512) in a respective block in a respective slot in the second table. The respective slot is indexed by the hash value h1(k1). The respective block has a first block number. In some embodiments, the first key and the packet-processing information associated with the first key are stored (514) in a collision element 220 in the respective block.

The first block number is stored (516) in a respective cell in a respective slot in the first table. The respective slot is indexed by the hash value h1(k1). The respective cell is indexed by the hash value h2(k1).

The storage operations 512 (e.g., including the operation 514) and 516 are performed by the table-maintenance module 119 (FIG. 1) in accordance with some embodiments.

In some embodiments, a third table (e.g., stub table 312, FIG. 3) is created (518, FIG. 5B) that is divided into a third plurality of slots (e.g., slots 312-0 through 312-(c-1)), with each slot being divided into a second plurality of cells (e.g., cells 214-0 through 214-(b-1)). In some embodiments, each cell is independently accessible in the memory 124 (e.g., in a single respective memory transaction.) In addition, a fourth table (e.g., hash table 302, FIG. 3) is created (520) that is divided into a fourth plurality of slots (e.g., slots 304-0 through 304-(c-1)), with each slot being divided into a second plurality of blocks (e.g., blocks 206-0 through 206-(p-1)). In some embodiments, each block is independently accessible in the memory 120 (e.g., in a single bus-request transaction, an example of which is a burst). In some embodiments, each block includes (522) multiple collision elements (e.g., collision elements 220-0 through 220-(q-1), FIG. 2B).

Hash values h3(k2) and h4(k2) are generated (524, 526) using a second key k2. For example, a third hash function is applied to the second key to determine the hash value h3(k2) and a fourth hash function is applied to the second key to determine the hash value h4(k2). The hashing operations 524 and 526 are performed, for example, by the hashing module 108 (FIG. 1).

The second key and packet-processing information associated with the second key are stored (528) in a respective block in a respective slot in the fourth table. The respective slot is indexed by the hash value h3(k2). The respective block has a second block number. In some embodiments, the second key and the packet-processing information associated with the second key are stored (530) in a collision element 220 in the respective block in the respective slot in the fourth table.

The second block number is stored (532) in a respective cell in a respective slot in the third table. The respective slot is indexed by the hash value h3(k2). The respective cell is indexed by the hash value h4(k2).

The storage operations 528 (e.g., including the operation 540) and 532 are performed by the table-maintenance module 119 (FIG. 1) in accordance with some embodiments. In some embodiments, the storage operations 528 and 532 are performed in response to determining that a slot indexed by h1(k2) in the second table cannot store the second key and its associated packet-processing information (e.g., because the slot is full).

The method 500 provides a lookup table with a high usage rate, high load factor, low collision rate, and low latency. While the method 500 includes a number of operations that appear to occur in a specific order, it should be apparent that the method 500 can include more or fewer operations and that some of the operations can be executed serially or in parallel. An order of two or more operations may be changed, performance of two or more operations may overlap, and two or more operations may be combined into a single operation.

In some embodiments, the methods 400 and/or 500 are performed in hardware. For example, the methods 400 and/or 500 are performed using one or more state machines in the processing circuitry 104 that correspond to the key-construction module 106, hashing module 108, table-access module 110, packet-processing module 116, and/or table-maintenance module 119. Alternatively, the methods 400 and/or 500 may be implemented in software. For example, the processing circuitry 104 may include a processor and may be coupled to nonvolatile memory that acts as a non-transitory computer-readable storage medium storing one or more programs configured for execution by the processor. The one or more programs may include instructions that, when executed by the processor, cause the system 100 to perform the methods 400 and/or 500. The one or more programs thus may include instructions that, when executed by the processor, achieve the functionality of the key-construction module 106, hashing module 108, table-access module 110, packet-processing module 116, and/or table-maintenance module 119.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A packet-processing method, comprising:
generating a first hash value and a second hash value using a first key constructed from information associated with a first packet;
reading a first block number from a cell in a slot in a first table, the slot in the first table being indexed by the first hash value and the cell being indexed by the second hash value;
performing a memory access directed to a block in a slot in a second table to read data including packet-processing information for the first packet from the block, the slot in the second table being indexed by the first hash value, the block being indexed by the first block number; and
processing the first packet in accordance with the packet-processing information for the first packet.

2. The method of claim 1, wherein:
generating the first hash value comprises applying a first hash function to the first key; and
generating the second hash value comprises applying a second hash function to the first key.

3. The method of claim 1, wherein performing the memory access directed to the block comprises reading the block from a memory storing the second table in a burst.

4. The method of claim 1, wherein:
the block stores a plurality of collision elements;
each collision element of the plurality of collision elements stores a respective key and respective packet-processing information associated with the respective key; and
performing the memory access directed to the block comprises reading the plurality of collision elements.

5. The method of claim 4, further comprising determining that a respective key of a collision element of the plurality of collision elements matches the first key;
wherein processing the first packet comprises processing the first packet in accordance with the respective packet-processing information in the collision element that has the respective key that matches the first key.

6. The method of claim 4, wherein:
reading the plurality of collision elements comprises determining a memory offset in a memory storing the second table and reading a location in the memory having the memory offset;
wherein determining the memory offset comprises calculating the expression (h1(k)*n+q*(first block number))*y, where h1(k) is the first hash value, n is a number of collision elements in each slot of the second table, q is a number of collision elements in the plurality of collision elements, and y is a size of each collision element.

7. The method of claim 1, wherein:
the first table is stored in static random-access memory (SRAM); and
the second table is stored in dynamic random-access memory (DRAM).

8. The method of claim 1, further comprising determining that the first block number is a valid block number for the second table;
wherein the memory access directed to the block is performed in response to determining that the first block number is a valid block number for the second table.

9. The method of claim 1, wherein:
the packet-processing information for the first packet specifies an output port; and
processing the first packet in accordance with the packet-processing information for the first packet comprises providing the first packet to the output port for transmission.

10. The method of claim 1, further comprising:
determining that the second table does not store packet-processing information for a second packet;
generating a third hash value and a fourth hash value using a second key constructed from information associated with the second packet;
reading a second block number from a cell in a slot in a third table, the slot in the third table being indexed by the third hash value, the cell in the slot in the third table being indexed by the fourth hash value;
performing a memory access directed to a block in a slot in a fourth table to read data including packet-processing information for the second packet from the block, the slot in the fourth table being indexed by the third hash value, the block in the slot in the fourth table being indexed by the second block number; and
processing the second packet in accordance with the packet-processing information for the second packet.

11. The method of claim 10, wherein:
generating the third hash value comprises applying a third hash function to the second key; and
generating the fourth hash value comprises applying a fourth hash function to the second key.

12. The method of claim 10, wherein determining that the second table does not store packet-processing information for the second packet comprises:
generating a fifth hash value and a sixth hash value using the second key;
in the first table, reading a cell indexed by the sixth hash value in a slot indexed by the fifth hash value; and
determining that a value read from the cell indexed by the sixth hash value in the slot indexed by the fifth hash value indicates that the second table does not store packet-processing information for the second packet.

13. The method of claim 10, wherein:
the block in the slot in the fourth table stores a plurality of collision elements;
each collision element of the plurality of collision elements stores a respective key and respective packet-processing information associated with the respective key; and
performing the memory access directed to the block in the slot in the fourth table comprises reading the plurality of collision elements.

14. The method of claim 13, further comprising determining that a respective key of a collision element of the plurality of collision elements matches the second key;
wherein processing the second packet comprises processing the second packet in accordance with the respective packet-processing information in the collision element that has the respective key that matches the second key.

15. The method of claim 13, wherein:
reading the plurality of collision elements comprises determining a memory offset in a memory storing the fourth table and reading a location in the memory having the memory offset;
wherein determining the memory offset comprises calculating the expression (h3(k)*n+q*(second block number))*y, where h3(k) is the third hash value, n is a number of collision elements in each slot of the fourth table, q is a number of collision elements in the plurality of collision elements, and y is a size of each collision element.

16. The method of claim 10, wherein:
the third table is stored in SRAM; and
the fourth table is stored in DRAM.

17. The method of claim 10, wherein performing the memory access directed to the block in the slot in the fourth table comprises reading the block in the slot in the fourth table from a memory storing the fourth table in a burst.

18. A method of maintaining a lookup table used for packet processing, comprising:
creating a first table divided into a first plurality of slots, each slot of the first plurality of slots being divided into a first plurality of cells;
creating a second table divided into a second plurality of slots, each slot of the second plurality of slots being divided into a first plurality of blocks;
generating a first hash value and a second hash value using a first key;
storing the first key and packet-processing information associated with the first key in a respective block in a respective slot in the second table, the respective slot in the second table being indexed by the first hash value, the respective block having a first block number; and
storing the first block number in a respective cell in a respective slot in the first table, the respective slot in the first table being indexed by the first hash value, the respective cell in the respective slot in the first table being indexed by the second hash value.

19. The method of claim 18, wherein:
each block of the first plurality of blocks includes multiple collision elements; and
storing the first key and the packet-processing information associated with the first key comprises storing the first key and the packet-processing information associated with the first key in a collision element in the respective block in the respective slot in the second table.

20. The method of claim 18, wherein:
creating the first table comprises storing the first table in a first memory;
creating the second table comprises storing the second table in a second memory; and
the method further comprises accessing respective blocks of the first plurality of blocks independently of other blocks of the first plurality of blocks.

21. The method of claim 20, further comprising accessing respective cells of the first plurality of cells independently of other cells of the first plurality of cells.

22. The method of claim 18, further comprising:
creating a third table divided into a third plurality of slots, each slot of the third plurality of slots being divided into a second plurality of cells;
creating a fourth table divided into a fourth plurality of slots, each slot of the fourth plurality of slots being divided into a second plurality of blocks;
generating a third hash value and a fourth hash value using a second key;
storing the second key and packet-processing information associated with the second key in a respective block in a respective slot in the fourth table, the respective slot in the fourth table being indexed by the third hash value, the respective block having a second block number; and
storing the second block number in a respective cell in a respective slot in the third table, the respective slot in the third table being indexed by the third hash value, the respective cell in the respective slot in the third table being indexed by the fourth hash value.

23. A packet-processing system, comprising:
a hashing module to generate a first hash value and a second hash value using a first key constructed from information associated with a first packet;
a table-access module to:
read a first block number from a cell in a slot in a first table, the slot in the first table being indexed by the first hash value and the cell being indexed by the second hash value; and
perform a memory access directed to a block in a slot in a second table to read data including packet-processing information from the block, the slot in the second table being indexed by the first hash value, the block being indexed by the first block number; and
a packet-processing module to process the first packet in accordance with packet-processing information read from the block.

24. The system of claim 23, wherein:
the table-access module is to read a plurality of collision elements from the block, wherein respective collision elements of the plurality of collision elements store respective keys and respective packet-processing information associated with the respective keys; and
the table-access module comprises comparison logic to determine that a respective key of a collision element of the plurality of collision elements matches the first key;
wherein the packet-processing module is to process the first packet in accordance with the respective packet-processing information in the collision element that has the respective key that matches the first key.

25. The system of claim 23, further comprising:
static random-access memory (SRAM) to store the first table; and
dynamic random-access memory (DRAM) to store the second table.

26. The system of claim 23, wherein the table-access module is further to determine whether the first block number is a valid block number for the second table and to perform the memory access directed to the block in the slot in the second table in response to determining that the first block number is a valid block number for the second table.

27. The system of claim 23, further comprising a plurality of ports to receive and transmit packets;
wherein the packet-processing module is to route the first packet to a respective port of the plurality of ports for transmission, using packet-processing information read from the block.

28. The system of claim 23, wherein:
the table-access module is further to determine that the second table does not store packet-processing information for a second packet;
the hashing module is further to generate a third hash value and a fourth hash value using a second key constructed from information associated with the second packet;
the table-access module is further to:
read a second block number from a cell in a slot in a third table, the slot in the third table being indexed by the third hash value, the cell in the slot in the third table being indexed by the fourth hash value; and
perform a memory access directed to a block in a slot in a fourth table to read data including packet-processing information, the slot in the fourth table being indexed by the third hash value, the block in the slot in the fourth table being indexed by the second block number; and
the packet-processing module is further to process the second packet in accordance with packet-processing information read from the block in the slot in the fourth table.

29. A packet-processing system, comprising:
means for hashing, comprising means for generating a first hash value and a second hash value using a first key constructed from information associated with a first packet;
means for reading tables, comprising:
means for reading a first block number from a cell in a slot in a first table, the slot in the first table being indexed by the first hash value and the cell being indexed by the second hash value;
means for performing a memory access directed to a block in a slot in a second table, the slot in the second table being indexed by the first hash value, the block being indexed by the first block number; and
means for processing packets, comprising means for processing the first packet in accordance with packet-processing information read from the block.

30. The system of claim 29, wherein:
the means for reading tables further comprises means for determining that the second table does not store packet-processing information for a second packet;
the means for hashing further comprises means for generating a third hash value and a fourth hash value using a second key constructed from information associated with the second packet;
the means for reading tables additionally comprises:
means for reading a second block number from a cell in a slot in a third table, the slot in the third table being indexed by the third hash value, the cell in the slot in the third table being indexed by the fourth hash value; and
means for performing a memory access directed to a block in a slot in a fourth table, the slot in the fourth table being indexed by the third hash value, the block in the slot in the fourth table being indexed by the second block number; and
the means for processing packets further comprises means for processing the second packet in accordance with packet-processing information read from the block in the slot in the fourth table.
